(19) United States
(12) Patent Application Publication
(10) Pub. No.: US 2018/0032524 A1
(43) Pub. Date: Feb. 1, 2018

(54) Document Recommendation Method Based on Skill

(71) Applicant: International Business Machines Corporation, Armonk, NY (US)

(72) Inventors: Donna K. Byron, Petersham, MA (US); Carmine M. DiMascio, West Roxbury, MA (US); Benjamin L. Johnson, Baltimore, MD (US); Jacquelyn A. Martino, Cold Spring, NY (US); Florian Pinel, New York, NY (US)

(21) Appl. No.: 15/223,918

(22) Filed: Jul. 29, 2016

(51) Int. Cl. G06F 17/30; G09B 5/12

(52) U.S. Cl. CPC G06F 17/3053; G09B 5/125

(57) ABSTRACT

A method, system and computer-usable medium are disclosed for recommending instructional content according to a user's level of skill. User input requesting instructional content is parsed to generate features associated with skills referenced in the request. The resulting features and user input are then processed to identify individual instances of instructional content that contain at least one skill referenced in the user input. In turn, the identified individual instances of instructional content are presented in ranked order to the user as recommended instructional content.

### BACKGROUND OF THE INVENTION

### Field of the Invention

The present invention relates in general to the field of computers and similar technologies, and in particular to software utilized in this field. Still more particularly, it relates to a method, system and computer-usable medium for recommending instructional content according to a user's level of skill.

### Description of the Related Art

Sources of instructional content, such as websites, generally have difficulty surfacing content commensurate with a given user's knowledge, skill or expertise related to a particular subject. Instead, searches for such content typically return results based upon the level of a user's interest, not their ability to comprehend or effectively utilize the substance of the material presented. As a result, it is not uncommon for users to be presented instructional content that is too complex to be of practical use, or conversely, too simple to be of interest.

Known approaches to this issue include manually tagging various forms of instructional content with coarse-grained skill assessments, such as “easy,” “hard,” “expert,” and so forth. However, such skill assessments are relative at best, and often inapplicable in practice. For example, a skill that may be considered “difficult” by one user may be considered “elementary” by another.

Other approaches include listing a set of prerequisite skills, abilities, or knowledge to make effective use of the content. However, these approaches may fail to accurately describe the degree of competency expected of the user. As an example, a user may be proficient at sawing a board or hammering a nail, but lack the knowledge required to frame a hip roof for a house. Consequently, a user may be challenged in creating a personalized, self-paced curriculum that provides progressively more challenging instructional content to allow them to become more proficient in a given subject area.

### SUMMARY OF THE INVENTION

A method, system and computer-usable medium are disclosed for recommending instructional content according to a user's level of skill. In various embodiments, user input requesting instructional content is parsed to generate features associated with skills referenced in the request. The resulting features and user input are then processed to identify individual instances of instructional content that contain at least one skill referenced in the user input. In turn, the identified individual instances of instructional content are presented to the user as recommended instructional content.

In certain embodiments, the individual instances of instructional content provided to the user as recommended instructional content are provided in ranked order. In these embodiments, the ranking is determined by the number of skills associated with the user within each individual instance of instructional content. In various embodiments, instances of instructional content containing greater numbers of skills associated with the user receive a higher ranking than those having a lesser number of such skills. In certain embodiments, the skills associated with the user are contained in a user skills competency profile.

In various embodiments, recommendation assessment input associated with the use of an instance of recommended instructional content by the user is received. In these embodiments, the recommendation assessment input may include a self-evaluation, a peer evaluation, an automated evaluation, or some combination thereof. In certain embodiments, the recommendation assessment input is used to update the user skills competency profile.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of an information handling system capable of performing computing operations;

FIG. 3 is a simplified block diagram of the operation of an instructional content recommendation system;

FIG. 4 is a generalized flowchart of the performance of instructional content skills assessment operations;

FIG. 5 is a generalized flowchart of the performance of user skills assessment operations;

FIG. 6 is a generalized flowchart of the performance of instructional content recommendation operations; and

FIG. 7 is a generalized flowchart of the performance of instructional content recommendation assessment operations.

### DETAILED DESCRIPTION

A method, system and computer-usable medium are disclosed for recommending instructional content according to a user's level of skill. The present invention may be a system, a method, and/or a computer program product. In addition, selected aspects of the present invention may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present invention may take the form of computer program product embodied in a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

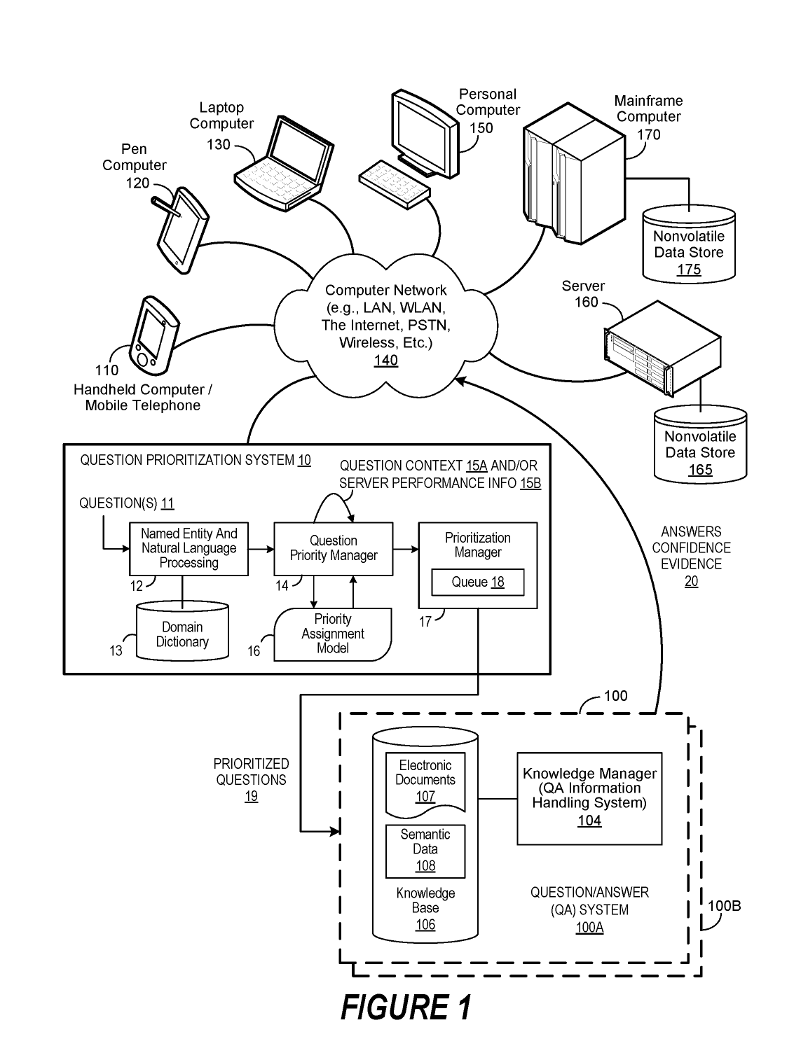

FIG. 1 depicts a schematic diagram of one illustrative embodiment of a question prioritization system 10 and question/answer (QA) system 100 connected to a computer network 140. The QA system 100 includes a knowledge manager 104 that is connected to a knowledge base 106 and configured to provide question/answer (QA) generation functionality for one or more content users who submit across the network 140 to the QA system 100. To assist with efficient sorting and presentation of questions to the QA system 100, the prioritization system 10 may be connected to the computer network 140 to receive user questions, and may include a plurality of subsystems which interact with cognitive systems, like the knowledge manager 100, to prioritize questions or requests being submitted to the knowledge manager 100.

The Named Entity subsystem 12 receives and processes each question 11 by using natural language (NL) processing to analyze each question and extract question topic information contained in the question, such as named entities, phrases, urgent terms, and/or other specified terms which are stored in one or more domain entity dictionaries 13. By leveraging a plurality of pluggable domain dictionaries relating to different domains or areas (e.g., travel, healthcare, electronics, game shows, financial services), the domain dictionary 11 enables critical and urgent words (e.g., “threat level”) from different domains (e.g., “travel”) to be identified in each question based on their presence in the domain dictionary 11. To this end, the Named Entity subsystem 12 may use a Natural Language Processing (NLP) routine to identify the question topic information in each question. As used herein, “NLP” refers to the field of computer science, artificial intelligence, and linguistics concerned with the interactions between computers and human (natural) languages. In this context, NLP is related to the area of human-computer interaction and natural language understanding by computer systems that enable computer systems to derive meaning from human or natural language input. For example, NLP can be used to derive meaning from a human-oriented question such as, “What is tallest mountain in North America?” and to identify specified terms, such as named entities, phrases, or urgent terms contained in the question. The process identifies key terms and attributes in the question and compares the identified terms to the stored terms in the domain dictionary 13.

The Question Priority Manager subsystem 14 performs additional processing on each question to extract question context information 15A. In addition or in the alternative, the Question Priority Manager subsystem 14 may also extract server performance information 15B for the question prioritization system 10 and/or QA system 100. In selected embodiments, the extracted question context information 15A may include data that identifies the user context and location when the question was submitted or received. For example, the extracted question context information 15A may include data that identifies the user who submitted the question (e.g., through login credentials), the device or computer which sent the question, the channel over which the question was submitted, the location of the user or device that sent the question, any special interest location indicator (e.g., hospital, public-safety answering point, etc.), or other context-related data for the question. The Question Priority Manager subsystem 14 may also determine or extract selected server performance data 15B for the processing of each question. In selected embodiments, the server performance information 15B may include operational metric data relating to the available processing resources at the question prioritization system 10 and/or QA system 100, such as operational or run-time data, CPU utilization data, available disk space data, bandwidth utilization data, etc. As part of the extracted information 15A/B, the Question Priority Manager subsystem 14 may identify the SLA or QoS processing requirements that apply to the question being analyzed, the history of analysis and feedback for the question or submitting user, and the like. Using the question topic information and extracted question context and/or server performance information, the Question Priority Manager subsystem 14 is configured to populate feature values for the Priority Assignment Model 16 which provides a machine learning predictive model for generating a target priority values for the question, such as by using an artificial intelligence (AI) rule-based logic to determine and assign a question urgency value to each question for purposes of prioritizing the response processing of each question by the QA system 100.

The Prioritization Manager subsystem 17 performs additional sort or rank processing to organize the received questions based on at least the associated target priority values such that high priority questions are put to the front of a prioritized question queue 18 for output as prioritized questions 19. In the question queue 18 of the Prioritization Manager subsystem 17, the highest priority question is placed at the front for delivery to the assigned QA system 100. In selected embodiments, the prioritized questions 19 from the Prioritization Manager subsystem 17 that have a specified target priority value may be assigned to a specific pipeline (e.g., QA System 100A) in the QA system cluster 100. As will be appreciated, the Prioritization Manager subsystem 17 may use the question queue 18 as a message queue to provide an asynchronous communications protocol for delivering prioritized questions 19 to the QA system 100 such that the Prioritization Manager subsystem 17 and QA system 100 do not need to interact with a question queue 18 at the same time by storing prioritized questions in the question queue 18 until the QA system 100 retrieves them. In this way, a wider asynchronous network supports the passing of prioritized questions as messages between different computer systems 100A, 100B, connecting multiple applications and multiple operating systems. Messages can also be passed from queue to queue in order for a message to reach the ultimate desired recipient. An example of a commercial implementation of such messaging software is IBM's Web Sphere MQ (previously MQ Series). In selected embodiments, the organizational function of the Prioritization Manager subsystem 17 may be configured to convert over-subscribing questions into asynchronous responses, even if they were asked in a synchronized fashion.

The QA system 100 may include one or more QA system pipelines 100A, 100B, each of which includes a computing device 104 (comprising one or more processors and one or more memories, and potentially any other computing device elements generally known in the art including buses, storage devices, communication interfaces, and the like) for processing questions received over the network 140 from one or more users at computing devices (e.g., 110, 120, 130) connected over the network 140 for communication with each other and with other devices or components via one or more wired and/or wireless data communication links, where each communication link may comprise one or more of wires, routers, switches, transmitters, receivers, or the like. In this networked arrangement, the QA system 100 and network 140 may enable question/answer (QA) generation functionality for one or more content users. Other embodiments of QA system 100 may be used with components, systems, sub-systems, and/or devices other than those that are depicted herein.

In each QA system pipeline 100A, 100B, a prioritized question 19 is received and prioritized for processing to generate an answer 20. In sequence, prioritized questions 19 are dequeued from the shared question queue 18, from which they are dequeued by the pipeline instances for processing in priority order rather than insertion order. In selected embodiments, the question queue 18 may be implemented based on a “priority heap” data structure. During processing within a QA system pipeline (e.g., 100A), questions may be split into many subtasks which run concurrently. A single pipeline instance can process a number of questions concurrently, but only a certain number of subtasks. In addition, each QA system pipeline may include a prioritized queue (not shown) to manage the processing order of these subtasks, with the top-level priority corresponding to the time that the corresponding question started (earliest has highest priority). However, it will be appreciated that such internal prioritization within each QA system pipeline may be augmented by the external target priority values generated for each question by the Question Priority Manager subsystem 14 to take precedence or ranking priority over the question start time. In this way, more important or higher priority questions can “fast track” through the QA system pipeline if it is busy with already-running questions.

In the QA system 100, the knowledge manager 104 may be configured to receive inputs from various sources. For example, knowledge manager 104 may receive input from the question prioritization system 10, network 140, a knowledge base or corpus of electronic documents 106 or other data, a content creator 108, content users, and other possible sources of input. In selected embodiments, some or all of the inputs to knowledge manager 104 may be routed through the network 140 and/or the question prioritization system 10. The various computing devices (e.g., 110, 120, 130, 150, 160, 170) on the network 140 may include access points for content creators and content users. Some of the computing devices may include devices for a database storing the corpus of data as the body of information used by the knowledge manager 104 to generate answers to cases. The network 140 may include local network connections and remote connections in various embodiments, such that knowledge manager 104 may operate in environments of any size, including local and global, e.g., the Internet. Additionally, knowledge manager 104 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in a document 106 for use as part of a corpus of data with knowledge manager 104. The document 106 may include any file, text, article, or source of data (e.g., scholarly articles, dictionary definitions, encyclopedia references, and the like) for use in knowledge manager 104. Content users may access knowledge manager 104 via a network connection or an Internet connection to the network 140, and may input questions to knowledge manager 104 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 104 may interpret the question and provide a response to the content user containing one or more answers to the question. In some embodiments, knowledge manager 104 may provide a response to users in a ranked list of answers.

In some illustrative embodiments, QA system 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input prioritized question 19 and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ system identifies candidate answers that surface as being significantly stronger than others and thus, generates a final answer, or ranked set of answers, for the input question. The QA system 100 then generates an output response or answer 20 with the final answer and associated confidence and supporting evidence. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

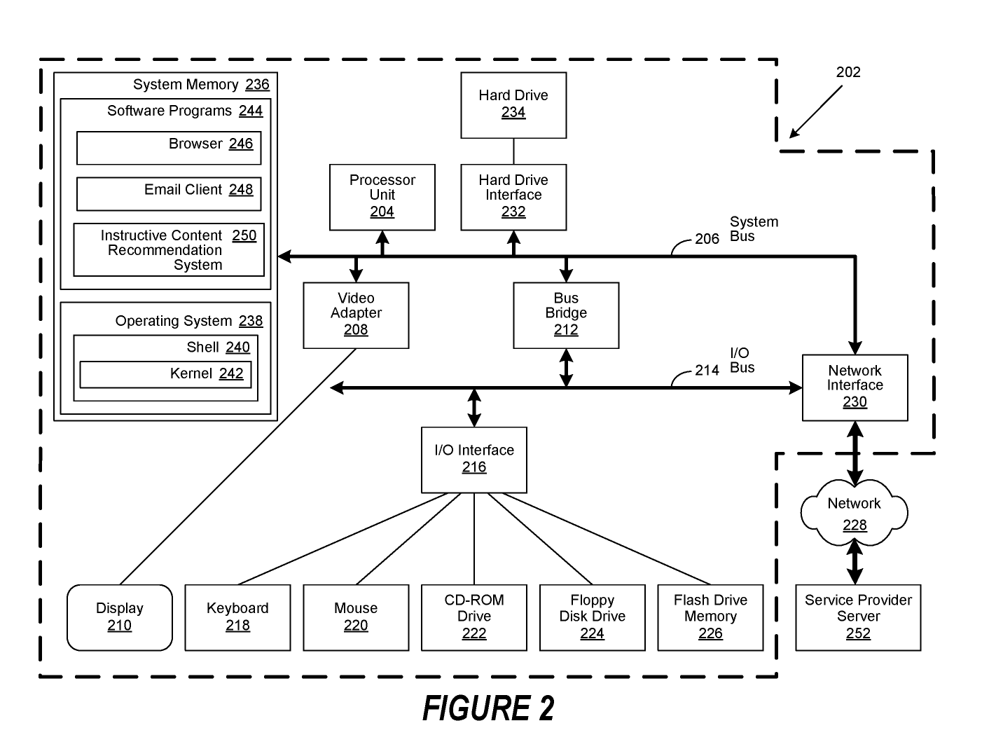

Types of information processing systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information processing systems include pen, or tablet, computer 120, laptop, or notebook, computer 130, personal computer system 150, and server 160. As shown, the various information processing systems can be networked together using computer network 140. Types of computer network 140 that can be used to interconnect the various information processing systems include Local Area Networks (LANs), Wireless Local Area Networks (WLANs), the Internet, the Public Switched Telephone Network (PSTN), other wireless networks, and any other network topology that can be used to interconnect the information processing systems. Many of the information processing systems include nonvolatile data stores, such as hard drives and/or nonvolatile memory. Some of the information processing systems may use separate nonvolatile data stores (e.g., server 160 utilizes nonvolatile data store 165, and mainframe computer 170 utilizes nonvolatile data store 175). The nonvolatile data store can be a component that is external to the various information processing systems or can be internal to one of the information processing systems. An illustrative example of an information processing system showing an exemplary processor and various components commonly accessed by the processor is shown in FIG. 2.

FIG. 2 illustrates an information processing system 202, more particularly, a processor and common components, which is a simplified example of a computer system capable of performing the computing operations described herein. Information processing system 202 includes a processor unit 204 that is coupled to a system bus 206. A video adapter 208, which controls a display 210, is also coupled to system bus 206. System bus 206 is coupled via a bus bridge 212 to an Input/Output (I/O) bus 214. An I/O interface 216 is coupled to I/O bus 214. The I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

The information processing system 202 is able to communicate with a service provider server 252 via a network 228 using a network interface 230, which is coupled to system bus 206. Network 228 may be an external network such as the Internet, or an internal network such as an Ethernet Network or a Virtual Private Network (VPN). Using network 228, client computer 202 is able to use the present invention to access service provider server 252.

A hard drive interface 232 is also coupled to system bus 206. Hard drive interface 232 interfaces with a hard drive 234. In a preferred embodiment, hard drive 234 populates a system memory 236, which is also coupled to system bus 206. Data that populates system memory 236 includes the information processing system's 202 operating system (OS) 238 and software programs 244.

OS 238 includes a shell 240 for providing transparent user access to resources such as software programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. While shell 240 generally is a text-based, line-oriented user interface, the present invention can also support other user interface modes, such as graphical, voice, gestural, etc.

As depicted, OS 238 also includes kernel 242, which includes lower levels of functionality for OS 238, including essential services required by other parts of OS 238 and software programs 244, including memory management, process and task management, disk management, and mouse and keyboard management. Software programs 244 may include a browser 246 and email client 248. Browser 246 includes program modules and instructions enabling a World Wide Web (WWW) client (i.e., information processing system 202) to send and receive network messages to the Internet using HyperText Transfer Protocol (HTTP) messaging, thus enabling communication with service provider server 252. In various embodiments, software programs 244 may also include an instructional content recommendation system 250. In these and other embodiments, the instructional content recommendation system 250 includes code for implementing the processes described hereinbelow. In one embodiment, information processing system 202 is able to download the instructional content recommendation system 250 from a service provider server 252.

The hardware elements depicted in the information processing system 202 are not intended to be exhaustive, but rather are representative to highlight components used by the present invention. For instance, the information processing system 202 may include alternate memory storage devices such as magnetic cassettes, Digital Versatile Disks (DVDs), Bernoulli cartridges, and the like. These and other variations are intended to be within the spirit, scope and intent of the present invention.

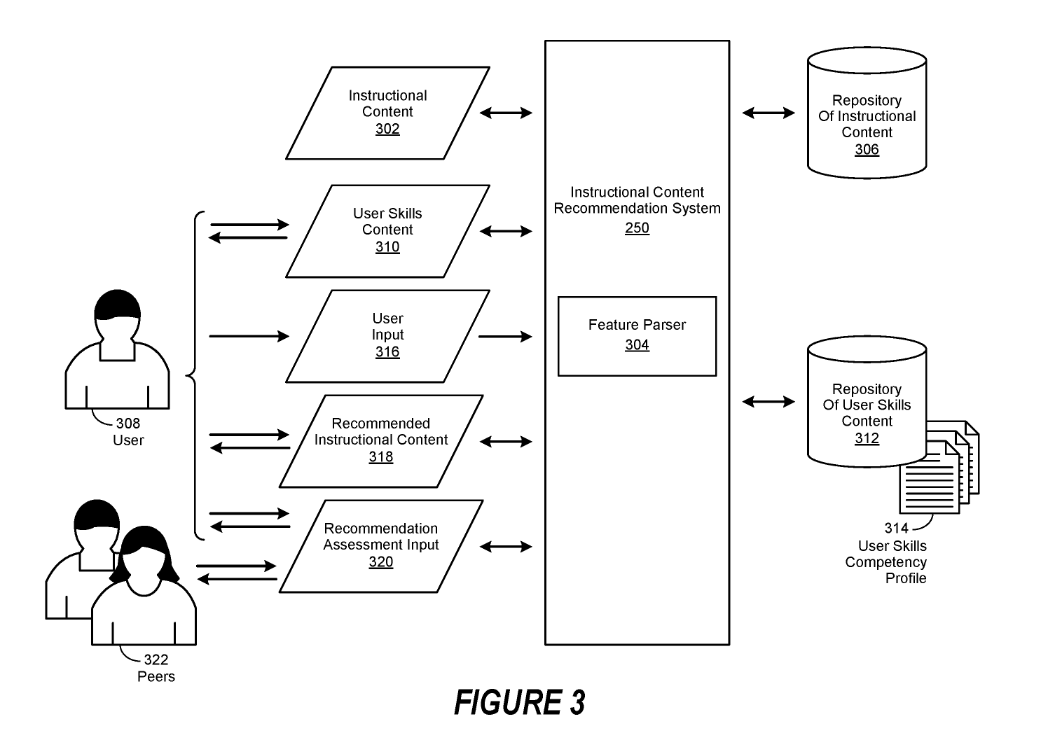

FIG. 3 is a simplified block diagram of the operation of an instructional content recommendation system implemented in accordance with an embodiment of the invention. In this embodiment, instructional content skills assessment operations are begun following the receipt of instructional content 302 by an instructional content recommendation system 250. As used herein, instructional content 302 broadly refers to any form of content that provides a user 308 a description of how to do something. In various embodiments, the corpus of instructional content 302 may include human readable text, a graphics file, an audio file, a video file, or some combination thereof. In certain embodiments, the corpus of instructional content 302 may include metadata associated with a text, graphics file, an audio file, a video file, or some combination thereof. Skilled practitioners of the art will realize that many such embodiments are possible and the foregoing is not intended to limit the spirit, scope or intent of the invention.

A subset of the corpus of instructional content 302 is then selected. The method by which the particular subset of instructional content 302 is selected is a matter of design choice. The instructional content 302 is then parsed by a feature parser 304 to generate features associated with skills referenced within the selected subset. As used herein, features broadly refer to phonemes, syllables, letters, words, base pairs, and so forth, contained within a corpus of content. As an example, a phrase beginning with an upper-case letter may signify the beginning of a sentence or possibly the name of a person, place or thing. As likewise used herein, a feature may also refer to static features such as term frequency, term length, and term position within individual sentences of a corpus of instructional content 302. In various embodiments, these various features are used in the performance of machine learning operations, familiar to those of skill in the art, to recommend one or more instances of instructional content 302 to a user 304.

As likewise used herein, an individual skill is broadly defined as the combination of an action, a recipient (or recipients) of that action, and any tools used to perform that action. For example, measuring a wood board in inches or feet is a skill that is distinct from measuring a quantity of flour in ounces or cups. In various embodiments, an individual skill is more particularly defined in the form of a verb, all direct objects of that verb, and all tools involved in performing an action related to the skill, as described by prepositional phrases. As an example, the phrase “cut the butter with a knife” would resolve to Action: cut, Theme: butter, Tool: knife. As another example, the phrase “smooth the board with a sander” would resolve to Action: smooth; Theme: board; Tool: sander. As yet another example, the phrase “draw a circle with the graphics program” would resolve to Action: draw; Theme: circle; Tool: graphics program.

A tool, as used herein, broadly refers to any physical implement, non-physical article, or methodology used to achieve a goal. As an example, a hammer is a physical tool commonly used to deliver a measure of force to a target area, such as the head of a nail. In this example, a variety of items can provide the base functionality of a hammer, including a common rock. As another example, a software program is a non-physical tool typically used to perform various functions, such as financial calculations, managing volumes of data, editing a digital image, and so forth. In this example, the software program may be used to perform a simple function, such as adding two numbers, or a complex function, such as analyzing market trends to predict the future cost of aviation fuel in a given region. As yet another example, a methodology is a tool that may be used to solve a problem or achieve better understanding of a particular field of study. In this example, a methodology may include a body of approaches, methods, techniques, rules, postulates, procedures, frameworks, or any combination thereof.

In various embodiments, one or more tools may be automatically elided, or implied, from an instruction within an individual instance of instructional content. As an example, the tool “orbital sander” may be elided from phrase “sand the board with an orbital sander,” as hand-sanding the board may produce the same result as the use of an orbital sander. Likewise, the use of a tool such as a sanding block, an orbital sander, or a stationary belt sander may be implied from the phrase “sand the board until it is smooth.” Skilled practitioners of the art will recognize that many such examples and embodiments of a tool are possible. Accordingly, the forgoing is not intended to limit the spirit, scope or intent of the invention.

The features generated by the feature parser 304 are then indexed to the selected subset of instructional content 302 and subsequently stored in a repository of instructional content 306. In one embodiment, only the index is stored in the repository of instructional content 306. In another embodiment, the features and its corresponding index are stored in the repository of instructional content 306. In these two embodiments, the subset of instructional content 302 may remain in its source location, be copied to another location, consolidated to a single location, distributed across multiple locations, or a combination thereof. In yet another embodiment, the features, the selected subset of instructional content 302, and their associated index, are stored in the repository of instructional content 306. Those of skill in the art will recognize that many such embodiments are possible and the foregoing is not intended to limit the spirit, scope or intent of the invention.

Once instructional content skills assessment operations are completed, user skills assessment operations are begun with the receipt of a corpus of user skills content 310. As used herein, user skills content 310 broadly refers to any form of content that contains a reference to a user's 308 degree of competency as it relates to a particular skill, described in greater detail herein. In various embodiments, the user skills content 310 may be in the form of human readable text, a graphics file, an audio file, a video file, or some combination thereof. In certain embodiments, the user skills content 310 may be in the form of metadata associated with a text, graphics file, an audio file, a video file, or some combination thereof.

As an example, a user 308 may post a message to an Internet forum that describes, step by step, with text, photographs, audio and video, their use of one or more tools while building an outdoor shed. In this example, the user skills content 310 may demonstrate the user's 308 proficiency, or competency, in using a drawing program to design the shed, a spreadsheet to estimate required materials and their associated costs, and power tools used during the shed's construction.

In one embodiment, a user's 308 social media profile is searched for examples of such user skills content 310. In this embodiment, the user skills content 310 may be in the form of “I [Action]ed the [Object] with a [Tool],” which implies the user 308 has at least a baseline competency in the referenced skill. In another embodiment, the user 308 may be explicitly asked whether they possess certain skills referenced within a given instance of instructional content 302. For example, if the user 308 is learning to cook, they may be asked “Are you comfortable [ ] slicing, [ ] grilling, [ ] deep frying?” and so forth. In yet another embodiment, the user 308 may have a history with a particular source of instructional content 302. In this embodiment, it may be inferred that the user 308 has at least some familiarity with skills described in various instances of instructional content they have previously viewed.

A subset of the corpus of user skills content 310 is selected and then processed by the feature parser 304 to generate features associated with skills referenced within the selected subset of user skills content 310. The method by which the particular subset of user skills content 310 is selected is a matter of design choice. The resulting features are then processed with the selected subset of user skills content 310 to generate or update an associated user skills competency profile 314, which in turn is stored in a repository of user skills content 312.

In one embodiment, only the user skills competency profile 314 is stored in the repository of user skills content 312. In another embodiment, the features and its corresponding user skills competency profile 314 are stored in the repository of user skills content 312. In these two embodiments, the subset of instructional content 310 may remain in its source location, be copied to another location, or a combination thereof. In yet another embodiment, the features, the selected subset of user skills content 310, and their associated user skills competency profile 314, are stored in the repository of instructional content 312. Skilled practitioners of skill in the art will recognize that many such embodiments are possible and the foregoing is not intended to limit the spirit, scope or intent of the invention.

Once user skills assessment operations are completed, instructional content recommendation operations are initiated by the receipt of user input 316 related to requesting instructional content 302. In various embodiments, the request for instructional content may be broad or specific. As an example, a novice woodworker may request information on how to apply various wood finishes. In contrast, an experienced woodworker may request information on the application of tung oil, and its respective curing time, for various tropical hardwoods.

The user input 316 is then parsed by the feature parser 304 to generate features associated with skills referenced in the user input 316. As an example, the user input 316 may be a statement stating, “I want to prepare pie dough with a food processor.” In this example, the generated features may include the words “prepare,” “pie dough,” and “food processor.” The user's 308 associated user skills competency profile 314 is then retrieved from the repository of user skills content 312 and processed with the previously-generated features to identify matching instructional content 302 stored in, or referenced by, the repository of instructional content 306. To continue the previous example, the features “prepare,” “pie dough,” and “food processor” may be used to retrieve a subset of instructional content 302 that references the preparation of pie dough, the use of a food processor, or any combination thereof.

In various embodiments, the matching instructional content 302 may include skills that are explicitly referenced within the user's 308 associated user skills competency profile 314. In certain embodiments, the matching instructional content 302 may include skills that are not explicitly referenced within the user skills competency profile 314. The user input 316 and the retrieved user skills competency profile 314 are then further processed to rank the matching instructional content 302 stored in, or referenced by, the repository of instructional content 306.

In continuance of the previous example, the user skills competency profile 314 may indicate that the user 308 knows how to manually make pie dough with a pastry cutter and likewise know how to use a food processor to slice or shred vegetables. However, the user skills competency profile 314 may not explicitly indicate the user 308 knows how to make pie dough with a food processor. Consequently, the user 308 may need to incrementally acquire a new skill, such as using a dough mixing blade with a food processor. Conversely, the user skills competency profile 314 may indicate the user 308 knows how to manually make pie dough with a pastry cutter, but has no indication of the user 308 having any knowledge of the operation of a food processor. As a result, it can be implied that the user 308 would first need to learn how to use a food processor, at least in principle, before it could be used to make pie dough.

In certain embodiments, the difficulty of a particular instance of instructional content 302 is based upon how many skills it requires beyond the skills the user 308 may have mastered, or alternatively, at least be familiar with. In various embodiments, the matching instructional content 302 is ranked according to how closely the skills it references matches the user's 308 proficiency or competence in those skills. For example, the skills referenced in the highest-ranked instance of instructional content may be a subset of skills referenced in the user's 308 associated user skills competency profile 314. Conversely, the skills referenced in the lowest-ranked instance of instructional content may not be present in the user's 308 user skills competency profile 314.

In one embodiment, the matching instructional content 302 is ranked according to the cost of acquiring, or learning to use, tools that the user may not already possess. In another embodiment, the matching instructional content 302 is ranked according to the prevalence of unknown skills. In this embodiment, each instance of instructional content may contain one or more skills the user 308 has not yet mastered, which in turn are compared to how common those skills may be within the corpus of instructional content 302. Likewise, the difficulty of a particular skill may be secondary in importance to how common that skill may be within the corpus of instructional content 302.

In yet another embodiment, the matching instructional content 302 is ranked according to the user's 308 interest or supplemental recommenders. For example, certain known automated recommenders attempt to gauge a user's 308 interest in the subject matter of a document or instance of instructional content. In this example, such approaches may be used to order the results of a skill-based recommendation of instructional content. The matching instructional content is then provided in ranked order as recommended instructional content 318 to the user 308.

Once instructional content recommendation operations are completed, instructional content recommendation assessment operations are initiated by the receipt of recommendation assessment input 320 related to the use of recommended instructional content 318 by a user 308. In various embodiments, the recommendation assessment input 320 relates to an evaluation of whether the recommended instructional content 318 met the user's 308 expectations, and if so, to what degree. In these embodiments, the recommendation assessment input 320 may include self-evaluation, peer-evaluation, or various forms of automated evaluation.

For example, the user 308 may be asked to assess their experiences in using the recommended instructional content 320, which is entered into a form. In certain embodiments, the form may be a series of multiple choice responses, free-form text, or some combination thereof. As another example, the user 308 may be asked to post some evidence of their results (e.g., text, image, video, etc.) on an online forum for the review of others. To continue the example, evaluation of a peer's 322 results in using recommended instructional content 318 may even be a prerequisite to submit a user's 308 own results for evaluation. One possible aspect of this example is users 308 would not have to evaluate results that involve skills that they've already mastered. As yet another example, certain results from the use of recommended instructional content 318, such as programming, may be automatically evaluated by software approaches familiar to those of skill in the art. The recommendation assessment input 320 is then processed to generate features associated with a user's success in using recommended instructional content 318. In turn, the resulting features are then processed with the recommendation assessment input 320 to update the user's 308 associated user skills competency profile 314 stored in the repository of user skills content 312.

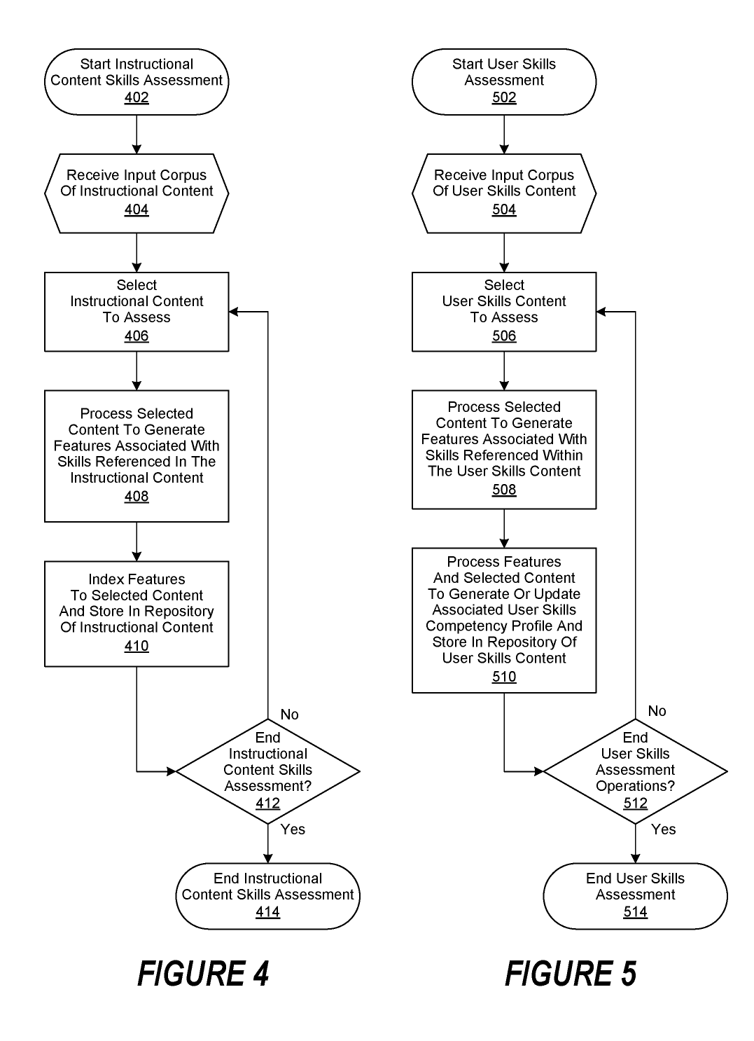

FIG. 4 is a generalized flowchart of the performance of instructional content skills assessment operations implemented in accordance with an embodiment of the invention. In this embodiment, instructional content skills assessment operations are begun in step 402, followed by an input corpus of instructional content in step 404. A subset of the corpus of instructional content is then selected in step 406. The method by which the particular subset of instructional content is selected is a matter of design choice. The instructional content is then processed in step 408 to generate features associated with skills referenced within the selected subset.

The features generated in step 408 are then indexed in step 410 to the selected subset of instructional content and subsequently stored in a repository of instructional content. A determination is then made in step 412 whether to end instructional content skills assessment operations. If not, then the process is continued, proceeding with step 406. Otherwise, instructional content skills assessment operations are ended in step 414.

FIG. 5 is a generalized flowchart of the performance of user skills assessment operations implemented in accordance with an embodiment of the invention. In this embodiment, user skills assessment operations are begun in step 502, followed by an input corpus of user skills content in step 504. A subset of the corpus of user skills content is then selected in step 506. The method by which the particular subset of user skills content is selected is a matter of design choice. The instructional content is then processed in step 508 to generate features associated with skills referenced within the selected subset. The features generated in step 508 are then processed with the selected subset of user skills content in step 510 to generate or update an associated user skills competency profile, which is then stored in a repository of user skills content. A determination is then made in step 512 whether to end user skills assessment operations. If not, then the process is continued, proceeding with step 506. Otherwise, instructional content skills assessment operations are ended in step 514.

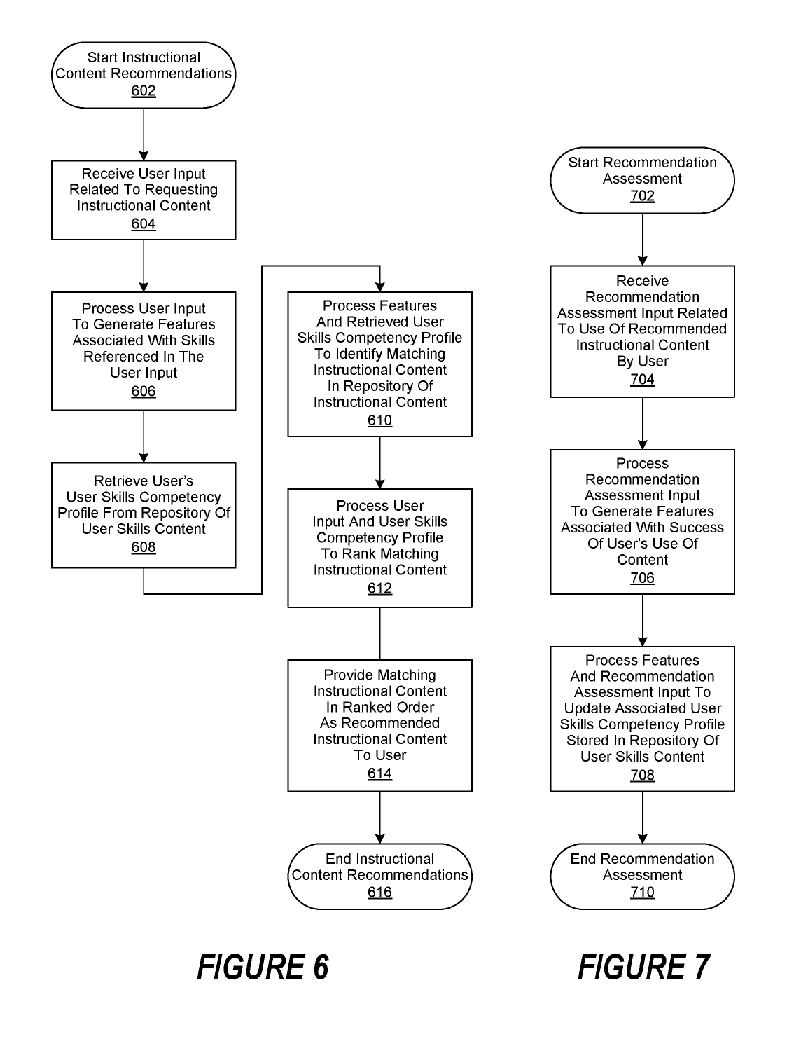

FIG. 6 is a generalized flowchart of the performance of instructional content recommendation operations implemented in accordance with an embodiment of the invention. In this embodiment, instructional content recommendation operations are begun in step 602, followed by the receipt in step 604 of user input related to requesting instructional content. In step 606, the user input is processed to generate features associated with skills referenced in the user input.

The user's user skills competency profile is then retrieved in step 608 from the repository of user skills content. In turn, the features and the retrieved user skills competency profile are processed in step 610 to identify matching instructional content stored in, or referenced by, the repository of instructional content. The user input and the retrieved user skills competency profile are further processed in step 612 to rank the matching instructional content stored in, or referenced by, the repository of instructional content. The matching instructional content is then provided in ranked order to the user as recommended instructional content in step 614 and instructional content recommendation operations are ended in step 616.

FIG. 7 is a generalized flowchart of the performance of instructional content recommendation assessment operations implemented in accordance with an embodiment of the invention. In this embodiment, instructional content recommendation assessment operations are begun in step 702, followed by the receipt in step 704 of recommendation assessment input related to the use of recommended instructional content by a user. The recommendation assessment input is then processed in step 706 to generate features associated with a user's success in using recommended instructional content. The features generated in step 706 are then processed with the recommendation assessment input to update the user's associated user skills competency profile stored in the repository of user skills content. Instructional content recommendation assessment operations are then ended in step 710.

Although the present invention has been described in detail, it should be understood that various changes, substitutions and alterations can be made hereto without departing from the spirit and scope of the invention as defined by the appended claims.

What is claimed is:

1. A computer-implemented method for recommending instructional content according to a user's level of skill, comprising:
receiving user input requesting instructional content;
parsing the user input to generate features associated with skills referenced in the user input;
processing the features and the user input to identify individual instances of instructional content that contain at least one skill referenced in the user input; and
providing the individual instances of instructional content as recommended instructional content to the user.

2. The method of claim 1, further comprising:
ranking the individual instances of instructional content provided to the user as recommended instructional content, the ranking determined by the number of skills associated with the user within each individual instance, the skills associated with the user contained in a user skills competency profile.

3. The method of claim 2, wherein:
individual instances of instructional content containing a greater number of skills associated with the user receive a higher ranking.

4. The method of claim 2, further comprising:
receiving recommendation assessment input associated with the use of an instance of recommended instructional content by the user.

5. The method of claim 4, wherein the recommendation assessment input comprises at least one of the group of:
a self-evaluation;
a peer-evaluation; and
an automated evaluation.

6. The method of claim 4, further comprising:
using the recommendation assessment input to update the user skills competency profile.

7. A system comprising:
a processor;
a data bus coupled to the processor; and
a computer-usable medium embodying computer program code, the computer-usable medium being coupled to the data bus, the computer program code used for recommending instructional content according to a user's level of skill and comprising instructions executable by the processor and configured for:
receiving user input requesting instructional content;
parsing the user input to generate features associated with skills referenced in the user input;
processing the features and the user input to identify individual instances of instructional content that contain at least one skill referenced in the user input; and
providing the individual instances of instructional content as recommended instructional content to the user.

8. The system of claim 7, further comprising:
ranking the individual instances of instructional content provided to the user as recommended instructional content, the ranking determined by the number of skills associated with the user within each individual instance, the skills associated with the user contained in a user skills competency profile.

9. The system of claim 8, wherein:
individual instances of instructional content containing a greater number of skills associated with the user receive a higher ranking.

10. The system of claim 8, further comprising:
receiving recommendation assessment input associated with the use of an instance of recommended instructional content by the user.

11. The system of claim 10, wherein the recommendation assessment input comprises at least one of the group of:
a self-evaluation;
a peer-evaluation; and
an automated evaluation.

12. The system of claim 10, further comprising:
using the recommendation assessment input to update the user skills competency profile.

13. A non-transitory, computer-readable storage medium embodying computer program code, the computer program code comprising computer executable instructions configured for:
receiving user input requesting instructional content;
parsing the user input to generate features associated with skills referenced in the user input;
processing the features and the user input to identify individual instances of instructional content that contain at least one skill referenced in the user input; and
providing the individual instances of instructional content as recommended instructional content to the user.

14. The non-transitory, computer-readable storage medium of claim 13, further comprising:
ranking the individual instances of instructional content provided to the user as recommended instructional content, the ranking determined by the number of skills associated with the user within each individual instance, the skills associated with the user contained in a user skills competency profile.

15. The non-transitory, computer-readable storage medium of claim 14, wherein:
individual instances of instructional content containing a greater number of skills associated with the user receive a higher ranking.

16. The non-transitory, computer-readable storage medium of claim 14, further comprising:
receiving recommendation assessment input associated with the use of an instance of recommended instructional content by the user.

17. The non-transitory, computer-readable storage medium of claim 16, wherein the recommendation assessment input comprises at least one of the group of:
a self-evaluation;
a peer-evaluation; and
an automated evaluation.

18. The non-transitory, computer-readable storage medium of claim 16, further comprising:
using the recommendation assessment input to update the user skills competency profile.

19. The non-transitory, computer-readable storage medium of claim 13, wherein the computer executable instructions are deployable to a client system from a server system at a remote location.

20. The non-transitory, computer-readable storage medium of claim 13, wherein the computer executable instructions are provided by a service provider to a user on an on-demand basis.
